(19) United States
(12) Patent Application Publication
(10) Pub. No.: US 2012/0265846 A1
(43) Pub. Date: Oct. 18, 2012

(54) SYSTEM AND METHOD OF COORDINATING A DEBT-RELIEF PROGRAM

(75) Inventor: Todd Emerson, Riverside, CA (US)

(73) Assignee: SPRINGBOARD NON PROFIT CONSUMER CREDIT MANAGEMENT, Riverside, CA (US)

(21) Appl. No.: 13/447,352

(22) Filed: Apr. 16, 2012

Related U.S. Application Data
(60) Provisional application No. 61/475,970, filed on Apr. 15, 2011.

(51) Int. Cl. G06F 17/30; G06F 15/16

(52) U.S. Cl. 709/217; 707/634; 707/E17.005

(57) ABSTRACT

A computer-implemented method, administered by a program intermediary, is disclosed for coordinating a debt relief program between a servicer and program provider. The method includes receiving a common data file for tracking information related to a program applicant. The method also includes transmitting the common data file related to the program applicant to the servicer and polling the servicer for changes made to the common data file. The method also includes downloading the changes made to the common data file made by the servicer and automatically updating the common data file with the changes made by the servicer. The method also includes transmitting the common data file including the changes made by the servicer to the program provider.

### CROSS-REFERENCE TO RELATED APPLICATIONS

This application claims priority to U.S. Provisional Patent Application No. 61/475,970, filed Apr. 15, 2011, which is hereby incorporated by reference in its entirety.

### TECHNICAL FIELD

The present disclosure relates generally to coordinating a debt-relief program.

### BACKGROUND

Debt-relief programs can be sponsored by both public and private entities. Some debt-relief programs can be targeted to homeowners struggling to make mortgage payments. Homeowners traditionally make mortgage payments to a company servicing the homeowner's mortgage loan, also known as the servicer. If a homeowner applies to a debt-relief program, becoming a program applicant, the debt-relief program provider needs to coordinate information about the debt-relief program and the program applicant with the servicer of the loan. If a servicer and program provider use different document systems or computer databases, coordinating the exchange of information between the servicer and program provider can require agents of the servicer and program provider to manually enter data to update respective systems and databases, using time and resources. If the program applicant receives a program award, both the servicer and program provider must continue to exchange information about the debt-relief program and the program applicant throughout the life of the program.

### SUMMARY

The disclosure relates to a program intermediary coordinating a debt-relief program.

In one implementation, a computer-implemented method, administered by a program intermediary, for coordinating a debt relief program between a servicer and program provider is disclosed. The method includes receiving a common data file, in a memory, for tracking information related to a program applicant and transmitting, by the computer, the common data file related to the program applicant to the servicer. The method further includes polling the servicer for changes made to the common data file, downloading, to the memory, the changes made to the common data file made by the servicer, automatically updating the common data file with the changes made by the servicer, and transmitting, by the computer, the common data file including the changes made by the servicer to the program provider.

In another implementation, a debt-relief coordination system is disclosed. The system includes a servicer computer including one or more processors and a memory. The system further includes a provider computer including one or more processors and a memory. The system also includes an intermediary computer configured to communicate with the servicer computer and the provider computer. The intermediary computer includes one or more processors for controlling the operations of the servicer computer and a memory for storing data and program instructions used by the one or more processors.

The one or more processors of the intermediary computer are configured to execute instructions stored in the memory to receive a common data file, in the memory, for tracking information related to a program applicant and transmit the common data file related to the program applicant to the servicer computer. The one or more processors are further configured to poll the servicer computer for changes made to the common data file, download, to the memory, the changes made to the common data file made by the servicer computer, automatically update the common data file with the changes made by the servicer computer, and transmit the common data file including the changes made by the servicer computer to the provider computer.

### BRIEF DESCRIPTION OF THE DRAWINGS

The description here makes reference to the accompanying drawings wherein like reference numerals refer to like parts throughout the several views, and where:

FIG. 1 is a block diagram of a system for coordinating a debt-relief program;

FIG. 2 is a block diagram showing an example of a program-intermediary device; and

FIG. 3 is a flow chart showing an example process for coordinating a debt-relief program.

FIG. 4 is a flow chart showing an example process for populating a common data file.

### DETAILED DESCRIPTION

In the debt-relief program coordination system and methods described here, a program intermediary can implement a combination of format and process standards that allow the program provider and servicer to communicate a number of events throughout the life cycle of a program award for a program applicant. The program intermediary can create a common data file for transmission of program information and program applicant information between the servicer and program provider. The common data file can be processed by the program intermediary's computer system, and the processing can include encapsulating changes made to the common data file by the servicer for automatic insertion into the program provider's document system. By using a common data file and automatically processing changes made to the common data file, the debt-relief coordination system can alleviate the need for manual data entry of changes into the program provider's document system, saving time and money.

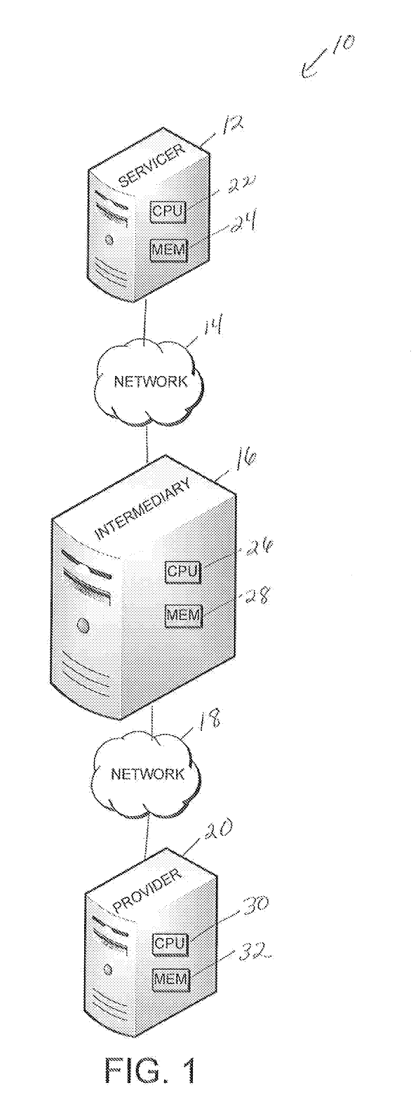

FIG. 1 is a block diagram of a system 10 in accordance with one implementation. The system 10 can include a servicer computer 12, a first network 14, an intermediary computer 16, a second network 18, and a provider computer 20.

The servicer computer 12 can include a processor such as central processing unit (CPU) 22 and a memory 24. In some embodiments, the servicer computer 12 can include two or more processors. Further, the servicer computer 12 can be implemented on two or more computing devices. In yet other embodiments, the servicer computer 12 can be implemented as a distributed system, using multiple computers and/or computing devices. The memory 24 can store data and program instructions used by the CPU 22. The servicer computer 12 can, for example, receive the common data file from the intermediary computer 16 and accept various types of program information and program applicant information from the intermediary computer 16.

The first network 14 can put the servicer computer 12 in communication with the intermediary computer 16 for transmitting the common data file and/or changes made to the common data file between the servicer computer 12 and the intermediary computer 16.

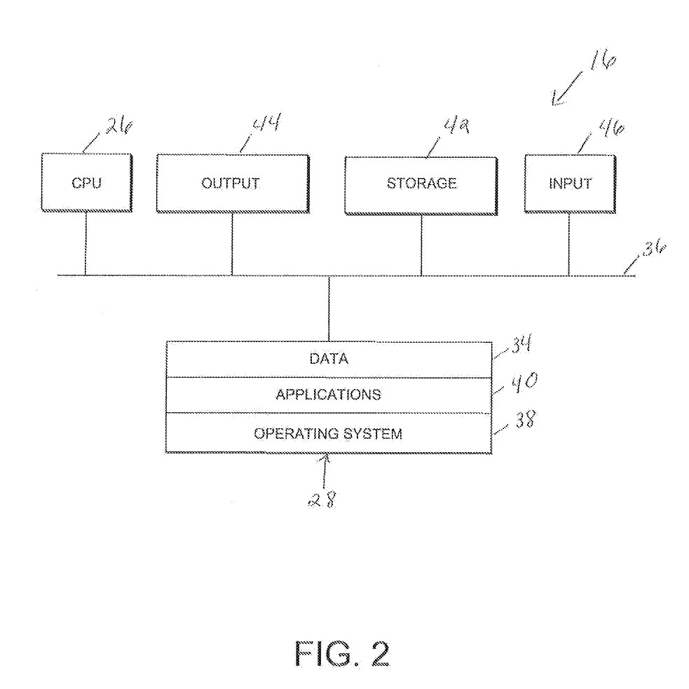

The intermediary computer 16 can include a processor such as CPU 26 and a memory 28. In some embodiments, the intermediary computer 16 can include two or more processors. Further, the intermediary computer 16 can be implemented on two or more computing devices. In yet other embodiments, the intermediary computer 16 can be implemented as a distributed system, using multiple computers and/or computing devices. The memory 28 can store data and program instructions that are used by the CPU 26. A more detailed example of the intermediary computer 16 and the components the intermediary computer 16 can include is further described in FIG. 2.

A second network 18 can put the intermediary computer 16 in communication with the provider computer 20. The second network 18 can put the intermediary computer 16 in communication with the provider computer 20 for transmitting the common data file and/or changes made to the common data file between the intermediary computer 16 and the provider computer 20. The second network 18 can be the same network or a different network from the first network 14.

The provider computer 20 can include a processor such as CPU 30 and a memory 32. In some embodiments, the provider computer 20 can include two or more processors. Further, the provider computer 20 can be implemented on two or more computing devices. In yet other embodiments, the provider computer 20 can be implemented as a distributed system, using multiple computers and/or computing devices. The memory 32 can store data and program instructions that are used by the CPU 30.

FIG. 2 is a block diagram of the intermediary computer 16 of FIG. 1.

The CPU 26 in the intermediary computer 16 can be a conventional central processing unit. Alternatively, the CPU 26 can be any other type of device, or multiple devices, capable of manipulating or processing information now-existing or hereafter developed. Although the disclosed embodiments can be practiced with a single processor as shown, e.g. CPU 26, advantages in speed and efficiency can be achieved using more than one processor.

The memory 28 in the intermediary computer 16 can be a random access memory device (RAM). Any other suitable type of storage device can also be used as the memory 28. The memory 28 can include code and data 34 that is accessed by the CPU 26 using a bus 36. The memory 28 can also include an operating system 38 and installed applications 40, the installed applications 40 including programs that permit the CPU 26 to perform the methods described here. For example, the installed applications 40 can include the common data file application described in FIG. 1. The intermediary computer 16 can also include additional storage 42, which can, for example, be a memory card, external memory, a flash drive, or any other form of suitable computer readable medium. Because the installed applications 40, including the common data file application, can contain a significant amount of information, they can be stored in whole or in part in the secondary storage 42 and loaded into the memory 28 as needed for processing.

The intermediary computer 16 can include or be coupled to one or more outputs 44, such as a display. The display can be a liquid crystal display (LCD), a cathode-ray tube (CRT), or any other type of display that allows output to be presented to a user, for example, in response to receiving a video signal. The intermediary computer 16 can also include an input 46, such as a keyboard, a mouse, a touch sensitive device, or a gesture sensitive input device that can receive user inputs and can output signals or data indicative of the user inputs to the CPU 26.

Although FIGS. 1 and 2 depict the CPUs 22, 26, 30 and the memories 24, 28, 32 of the servicer computer 12, intermediary computer 16, and provider computer 20 as being integrated into single units, other configurations can be utilized. The operations of the CPUs 22, 26, 30 can be distributed across multiple machines (each machine having one or more of processors) which can be coupled directly or across a local area or other network. The memories 24, 28, 32 can be distributed across multiple machines such as network-based memory or memory in multiple machines performing the operations of the servicer computer 12, intermediary computer 16, and provider computer 20. Although depicted here as a single bus, the bus 36 of the intermediary computer 16 can be composed of multiple buses. Further, the secondary storage 42 can be directly coupled to the other components of the intermediary computer 16 or can be accessed via a network and can comprise a single integrated unit such as a memory card or multiple units such as multiple memory cards. The servicer computer 12, intermediary computer 16, and provider computer 20 can thus be implemented in a wide variety of configurations.

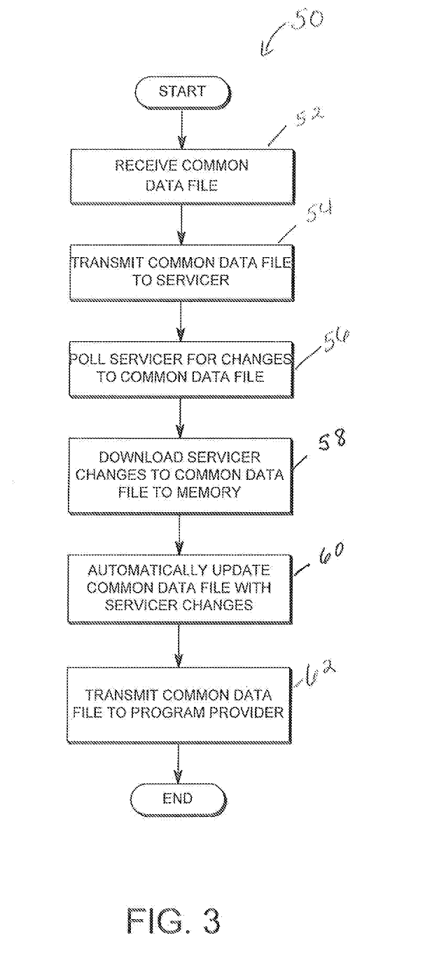

FIG. 3 is a flow chart showing an example processes 50 for coordinating a debt-relief program between a servicer and program provider. The process 50 in FIG. 3 can be performed by the intermediary computer 16 as part of the system 10 as shown in FIG. 1.

In stage 52, the intermediary computer 16 can receive a common data file in the memory 28 of the intermediary computer 16 for tracking information related to a program applicant. The common data file can be a combination of formatting and process standards agreed upon by the servicer and program provider and implemented by the program intermediary. For example, the format standard for the common data file can be a spreadsheet, and the servicer and program provider can agree to track information related to a program applicant using a spreadsheet. Information related to the program applicant can include the applicant's name and address as well as information related to the loan for which the applicant seeks debt relief.

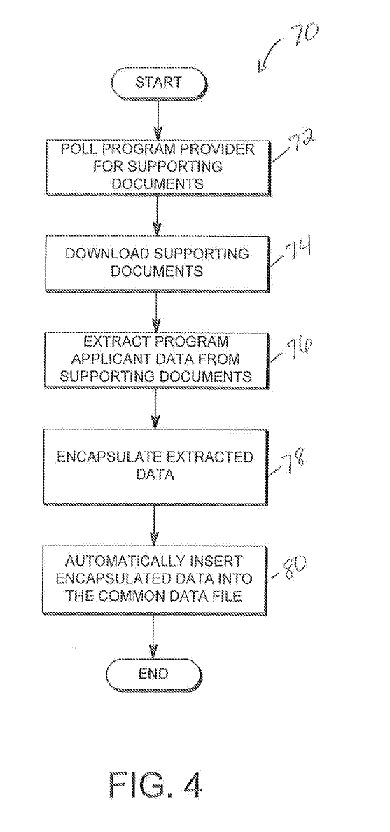

Receiving the common data file in the memory 28 of the intermediary computer 16 can also include the program intermediary creating the common data file and storing the common data file in the memory 28. Creating the common data file can include identifying the software version used by the servicer and basing the common data file at least in part on the software version used by the servicer. For example, the program intermediary can identify that the servicer uses a certain version of spreadsheet software for normal business operations and can thus structure the common data file to be compatible with the version of spreadsheet software used by the servicer. Additional details regarding the creation of the common data file are described below in FIG. 4.

In stage 54, the intermediary computer 16 can transmit the common data file related to a given program applicant to the servicer. The transmission can be implemented over the first network 14 coupling the intermediary computer 16 and servicer computer 12. Since the common data file can contain private information related to the applicant and the applicant's loan, the transmission of the common data file can be accomplished using secure file transfer protocol (SFTP), or any other method for secure transmission of information. The transmission protocol can be unique for each servicer and program provider, in that user names, passwords, site addresses, and directory structures can be tailored to the servicer and program provider.

In stage 56, the intermediary computer 16 can poll the servicer for changes made to the common data file. Polling the servicer can include the intermediary computer 16 communicating over the first network 14 with the servicer computer 12 and identifying any changes made to the common data file by the servicer. Polling the servicer can also include the servicer computer 12 communicating over the first network 14 with the intermediary computer 16 to identify that changes have been made to the common data file as stored on the servicer computer 12. Additional details regarding how changes can be made to the common data file are described below in FIG. 4.

In stage 58, the intermediary computer 16 can download the changes made to the common data file by the servicer to the memory 28. For example, if polling the servicer identified that changes were made to the common data file, those changes can be saved in the memory 28 of the intermediary computer 16.

In stage 60, the intermediary computer 16 can automatically update the common data file with the changes made by the servicer. For example, the intermediary computer 16 can encapsulate the changes made to the common data file by the servicer for automatic insertion into a least one program provider document and link the encapsulated information to the common data file. By encapsulating the changes made to common data file by the servicer, the program intermediary is formatting the common data file to populate at least one program provider document with the applicable changes to program applicant information. This can relieve agents of the program provider the burden of entering changes manually.

In stage 62, the intermediary computer 16 can transmit the common data file including the changes made by the servicer to the program provider. As described in stage 60, the changes made by the servicer can be encapsulated for automatic insertion into at least one program provider document. The insertion can be automatic in the sense that no agent of the program provider will need to manually enter the changed information into a program provider document. The information will be updated by command of the common data file. Again, because the information being transmitted about a program applicant or the program applicant's loan can be sensitive, or private information, the transmission of the common data file between the intermediary computer 16 and the program provider computer 20 over the second network 18 can be accomplished using secure file transfer protocol (SFTP), or any other method for secure transmission of information. After the common data file is transmitted to the program provider, the process 50 ends.

FIG. 4 is a flow chart showing an example process 70 for populating a common data file. As described above, the program intermediary can receive the common data file in the memory 28 of the intermediary computer 16, which can include creating the common data file. Creating the common data file can include populating the common data file with available information related to the program applicant and program applicant's loan.

In stage 72, the intermediary computer 16 can poll the program provider for supporting documents related to the program applicant. A supporting document can be a document related to the application of a program applicant other than the common data file. The program provider can have one or more supporting documents stored in the program provider document system which can be coupled to the provider computer 20. The intermediary computer 16 can, for example, communicate with the provider computer 20 over the second network 18 and can review the program provider document system to search for supporting documents related to a given program applicant.

In stage 74, the intermediary computer 16 can download the supporting documents found in the program provider document system to the memory 28. For example, if polling the program provider identified one or more supporting documents, the one or more supporting documents can be extracted from the program provider document system and saved in the memory 28 of the intermediary computer 16. In one embodiment, the supporting documents can be transmitted from the intermediary computer 16 to the servicer computer 12 over the first network 14 for user by the servicer.

In stage 76, the intermediary computer 16 can extract data related to the program applicant from the supporting documents. For example, if supporting documents include information related to the program applicant or the program applicant's loan, the information can be extracted and saved as data in the memory 28 of the intermediary computer 16.

In stage 78, the intermediary computer 16 can encapsulate the data related to the program applicant from the supporting documents. By encapsulating the data related to the program applicant, the program intermediary is formatting the data to populate the common data file with the program applicant information automatically. This can relieve agents of the program intermediary the burden of entering the information manually.

In stage 80, the intermediary computer 16 can automatically insert the encapsulated data into the common data file. The automatic insertion of encapsulated data related to the program applicant and extracted from supporting documents found in the program provider document system can be one step in the creation of the common data file described above in FIG. 3. After the encapsulated data is inserted into the common data file, the process 70 ends. As discussed, the process 70 described in FIG. 4 can be one example of how the common data file is received by the intermediary computer 16 as described in stage 52 of the process 50 shown in FIG. 3.

The embodiments of the servicer computer 12, intermediary computer 16, and provider computer 20 (and the algorithms, methods, instructions etc. stored thereon and/or executed thereby) can be realized in hardware including, for example, intellectual property (IP) cores, application-specific integrated circuits (ASICs), programmable logic arrays, optical processors, programmable logic controllers, microcode, firmware, microcontrollers, servers, microprocessors, digital signal processors or any other suitable circuit. In the claims, the term “processor” should be understood as encompassing any the foregoing, either singly or in combination. The terms “signal” and “data” are used interchangeably. Further, portions of servicer computer 12, intermediary computer 16, and provider computer 20 do not necessarily have to be implemented in the same manner.

In one embodiment, the servicer computer 12, intermediary computer 16, and provider computer 20 can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Further, all or a portion of embodiments of the present disclosure can take the form of a computer program product accessible from, for example, a non-transitory computer-usable or computer-readable medium. A non-transitory computer-usable or computer-readable medium can be any device that can, for example, tangibly contain, store, communicate, or transport the program for use by or in connection with any processor. The non-transitory medium can be, for example, an electronic device, magnetic device, optical device, electromagnetic device, or a semiconductor device. Other suitable mediums are also available.

While this disclosure includes what is presently considered to be the most practical and preferred embodiments, it is to be understood that the disclosure is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A computer-implemented method, administered by a program intermediary, for coordinating a debt relief program between a servicer and program provider, comprising:
receiving a common data file, in a memory, for tracking information related to a program applicant;
transmitting, by the computer, the common data file related to the program applicant to the servicer;
polling the servicer for changes made to the common data file;
downloading, to the memory, the changes made to the common data file made by the servicer;
automatically updating the common data file with the changes made by the servicer; and
transmitting, by the computer, the common data file including the changes made by the servicer to the program provider.

2. The method of claim 1 wherein receiving the common data file includes creating the common data file and storing the common data file in the memory.

3. The method of claim 2 wherein creating the common data file includes identifying the software version used by the servicer and basing the common data file at least in part on the software version used by the servicer.

4. The method of claim 1 wherein automatically updating the common data file with the changes made by the servicer includes encapsulating the changes made to the common data file by the servicer for automatic insertion into at least one program provider document.

5. The method of claim 1, further comprising:
polling the program provider for supporting documents related to the program applicant; and
downloading, to the memory, the supporting documents.

6. The method of claim 5, further comprising:
transmitting, by the computer, the supporting documents to the servicer.

7. The method of claim 5, further comprising:
extracting data related to the program applicant from the supporting documents; and
encapsulating the data extracted from the supporting documents for automatic insertion into the common data file.

8. The method of claim 5 wherein downloading the supporting documents includes extracting the supporting documents from at least one program provider document system.

9. The method of claim 1 wherein transmitting the common data file related to the program applicant to the servicer includes transferring the common data file using SFTP.

10. The method of claim 1 wherein transmitting the common data file including the changes made by the servicer to the program provider includes transferring the common data file using SFTP.

11. A debt-relief coordination system, comprising:
a servicer computer including:
one or more processors; and
memory;
a provider computer including:
one or more processors; and
memory; and
an intermediary computer configured to communicate with the servicer computer and the provider computer, the intermediary computer including:
one or more processors for controlling the operations of the servicer computer; and
a memory for storing data and program instructions used by the one or more processors, wherein the one or more processors are configured to execute instructions stored in the memory to:
receive a common data file, in the memory, for tracking information related to a program applicant;
transmit the common data file related to the program applicant to the servicer computer;
poll the servicer computer for changes made to the common data file;
download, to the memory, the changes made to the common data file made by the servicer computer;
automatically update the common data file with the changes made by the servicer computer; and
transmit the common data file including the changes made by the servicer computer to the provider computer.

12. The system of claim 11, wherein receiving the common data file includes creating the common data file and storing the common data file in the memory.

13. The system of claim 12, wherein creating the common data file includes identifying the software version used by the servicer computer and basing the common data file at least in part on the software version used by the servicer computer.

14. The system of claim 11, wherein automatically updating the common data file with the changes made by the servicer computer includes encapsulating the changes made to the common data file by the servicer computer for automatic insertion into at least one program provider document.

15. The system of claim 11, wherein the one or more processors of the intermediary computer are further configured to:
poll the provider computer for supporting documents related to the program applicant; and
download, to the memory, the supporting documents.

16. The system of claim 15, wherein the one or more processors of the intermediary computer are further configured to:
transmit the supporting documents to the servicer computer.

17. The system of claim 15, wherein the one or more processors of the intermediary computer are further configured to:
extract data related to the program applicant from the supporting documents; and
encapsulate the data extracted from the supporting documents for automatic insertion into the common data file.

18. The system of claim 15, wherein downloading the supporting documents includes extracting the supporting documents from at least one program provider document system.

19. The system of claim 11, wherein transmitting the common data file related to the program applicant to the servicer computer includes transferring the common data file using SFTP.

20. The system of claim 11, wherein transmitting the common data file including the changes made by the servicer to the provider computer includes transferring the common data file using SFTP.
